(19) United States
(12) Patent Application Publication
(10) Pub. No.: US 2011/0276203 A1
(43) Pub. Date: Nov. 10, 2011

(54) Method for Determining a Characteristic of a Track Condition Parameter

(75) Inventor: Peter Häse, Uster (CH)

(73) Assignee: BOMBARDIER TRANSPORTATION GMBH, Berlin (DE)

(21) Appl. No.: 13/120,266

(22) PCT Filed: Sep. 23, 2009
(86) PCT No.: PCT/EP2009/062329

§ 371 Date: Jun. 3, 2011

(30) Foreign Application Priority Data
Sep. 23, 2008 (DE) 10 2008 048 601.9

(51) Int. Cl. B61L 23/04; G05D 1/02

(52) U.S. Cl. 701/19; 246/120

(57) ABSTRACT

A method for determining a characteristic of at least one position parameter, in particular of a disruption in the position parameter, of a track for a vehicle, in which detection values of at least one detection parameter affected by the position parameter are detected on a vehicle driving along a section of the track, and wherein the at least one position parameter for the track section is determined from the detection values. The current value of the position parameter is determined from the detection values as a function of the model data of a previously determined vehicle model of the vehicle, wherein a relationship between the position parameter and the at least one detection parameter affected by the position parameter is generated by way of the vehicle model.

The present invention relates to a method for determining a characteristic of at least one condition parameter, in particular a condition parameter disturbance, of a track for a vehicle, in which detection values of at least one detection variable affected by the condition parameter are detected on a vehicle driving along a section of the track, and the at least one condition parameter for the track section is determined from the detection values. The present invention also relates to a method for controlling a vehicle and to a vehicle for carrying out the method according to the invention.

In vehicles, in particular rail vehicles, the dynamic loading of the vehicle components (specifically the running gear components, of course) during operation depends to a large extent on the condition of the track being travelled. This condition of the track is represented inter alia by what are known as condition parameters which in the case of a rail vehicle are usually subsumed under the term ‘track condition’. The track condition usually denotes the position of a railway track in the horizontal and/or vertical direction(s) and optionally the relative height level of the two rails of the track.

The less a track differs from its desired track condition, in other words the smaller the track condition faults are, the higher is the quality of the track and the lower are the dynamic loads on the vehicle resulting from such track condition faults. The condition of the tracks is becoming increasingly more important financially with the advancing financial separation between the operators of the infrastructure (rail network, etc.) and the operators of the vehicles used on it. In particular, the track usage charges (i.e. the fee for using the infrastructure) that may be attained by the infrastructure operators are becoming increasingly dependent on the quality of the line, so reliable information about the condition of the track is becoming increasingly more important.

Previously, the track condition of a certain track section has been laboriously determined using what are known as measuring vehicles which directly detect, using a correspondingly complex sensor system, store and optionally make available in the form of suitable data records the characteristics of the condition parameters of the track. One problem in this connection is that, firstly, the measuring vehicles are relatively expensive (to acquire and to run) and, secondly, (owing to the low achievable speeds during the measuring run) can only be used at certain times (for example at night, at weekends, etc.) when the track is used less in order not to affect the regular traffic on this track. It is precisely on track sections that are heavily used, on which rapid deterioration of the track condition is to be expected, that this leads to insufficiently long intervals between measuring runs.

It is known from the article by Charles, G. A., Goodall, R. M., Dixon. R.: “Wheel-Rail Profile Estimation”, (Proceedings of IET International Conference on Railway Condition Monitoring, The IET International Conference on Railway Condition Monitoring 2006, Birmingham, November 2006, pp 32-37, ISBN 0 86341 732 9) to draw conclusions about the actual condition of the current wheel-rail pairing, in particular the effective conicity of the rail-wheel pairing, by way of appropriate sensors on the vehicle and appropriate calculation algorithms (in particular what is referred to as an observer algorithm, known from control engineering, in the form of what is referred to as a Kalman filter). However, in this case only knowledge about the current condition of the wheel-rail pairing is obtained which is also significantly affected by the condition of the wheel used. There is no isolated consideration of the rail, however, which could provide information about the current condition of the track.

The object underlying the present invention is therefore to provide a method and a vehicle of the type mentioned initially which do not exhibit the drawbacks mentioned above, or at least exhibit them to a lesser extent, and which, in particular, allows the characteristics of the condition parameter of a track section to be detected and used in a simple and inexpensive manner.

The present invention achieves this object starting from a method according to preamble of claim 1 by the features disclosed in the characterizing part of claim 1.

The present invention is based on the teaching that simple and inexpensive detection and use of the characteristics of the condition parameter of a track section is made possible if the current value of the condition parameter is determined from the detection values as a function of the model data from a previously determined vehicle model of the vehicle, wherein a relationship between the condition parameter and the at least one detection variable affected by the condition parameter is generated by way of the vehicle model. By way of a vehicle model of this kind (established in advance) it is advantageously possible to easily draw conclusions (optionally in real time) about the desired condition parameter. It may involve any suitable mathematical model by way of which a relationship between the detection variable and the condition parameter may be generated.

According to one aspect, the present invention therefore relates to a method for determining a characteristic of at least one condition parameter, in particular a condition parameter disturbance, of a track for a vehicle, in which detection values of at least one detection variable affected by the condition parameter are detected on a vehicle driving along a section of the track, and the at least one condition parameter for the track section is determined from the detection values. The current value of the condition parameter is determined from the detection values as a function of the model data from a previously determined vehicle model of the vehicle, wherein a relationship between the condition parameter and the at least one detection variable affected by the condition parameter is generated by way of the vehicle model.

Under certain conditions it may be provided that the current value of the condition parameter is calculated in a recursive method from the detection values as a function of the model data from the vehicle model. The vehicle model is configured in such a way here that it directly reflects the relationship between the detection values of the detection variable and the desired condition parameter(s) or (with adequate precision, for example in a sufficiently good approximation) allows a retrograde calculation, based on the detection values of the detection variable, leading to the desired condition parameter(s).

In a further preferred and comparatively universally applicable variant of the present invention an observer algorithm sufficiently known from the field of control engineering is used which produces as a function of a current detection value an associated current estimated value of at least one state variable of the vehicle which is affected by the condition parameter, and the current value of the condition parameter is then determined as a function of the model data from a previously determined vehicle model of the vehicle. The vehicle model can, as mentioned, be any suitable mathematical model which represents the relationship between the condition parameter and at least one state variable. Such models are sufficiently known from the field of vehicle dynamics.

Using the present method it is possible inter alia to draw sufficiently reliable conclusions about the desired condition parameter(s), in other words the current state of the track section being travelled on therefore, using the detection values from detection devices (for example the measured values from sensors on the vehicle) that are eventually present on the vehicle anyway. By suitable modeling of the vehicle (i.e. a suitable choice of the vehicle model) and suitable configuration of the observer algorithm it is possible, using the present invention, to nevertheless draw such conclusions quickly and sufficiently accurately from detection variables which do not of themselves allow any direct conclusions about the condition parameter.

In particular, it is possible to determine the characteristics of the condition parameter in real time during the vehicle's journey on the track section. A further aspect connected with such real time determination of the condition of the track currently being travelled on lies in the possibility of controlling the vehicle as a function of this condition. With rail vehicles in particular, trailing running gears can be actively influenced using the information about the condition parameter, i.e. the condition of the track (obtained at a leading running gear, for example), in order to achieve, by way of example, particularly smooth vehicle running and/or desired, optionally optimized, wear behavior of the vehicle components, in particular the running gear components.

The characteristics of the relevant condition parameter may be the current (optionally absolute) value of the condition parameter. In addition or as an alternative, it may also be a difference in the condition parameter from a pre-defined setpoint value, in other words a condition parameter disturbance or a condition parameter fault.

According to a further aspect, the present invention therefore relates to a method for determining a characteristic of at least one condition parameter, in particular, a condition parameter disturbance, of a track for a vehicle, in which detection values of at least one detection variable affected by the condition parameter are detected on a vehicle driving along a section of the track, and the at least one condition parameter for the track section is determined from the detection values. The at least one condition parameter is determined for the track section using an observer algorithm, wherein the observer algorithm is configured to produce, as a function of a current detection value, an associated current estimated value of at least one state variable of the vehicle which is affected by the condition parameter. The current value of the condition parameter is determined as a function of the model data from a vehicle model determined in advance, wherein the vehicle model represents the relationship between the condition parameter and the at least one state variable.

As already mentioned, any suitable mathematical model may be used for the vehicle model which represents the different bodies of the vehicle and their coupling. The vehicle model is preferably determined by using a, in particular non-linear, dynamic multi-body model. Multi-body models of this kind are sufficiently known from the field of vehicle dynamics and are frequently used for predetermining the driving safety and running quality of vehicles.

These models (occasionally also called dynamic multi-body systems) are usually non-linear models. To simplify the calculations to be carried out (in particular with regard to a real-time determination of the condition parameter), the model is linearized by a suitable (sufficiently known) procedure, so a linear state space model is obtained as the vehicle model. The inputs of the vehicle model then form the characteristics of the desired condition parameter(s) that are to be determined (in the case of a rail vehicle the track condition or the track condition disturbance, for example), while the outputs represent the relevant detection variable or variables. The position or speed of certain vehicle components of interest, by way of example, (in the case of a rail vehicle the wheels or wheel sets, the running gear frame or other vehicle components such as the wagon body for example) are then designated as states of the modeled system.

The present method according to the invention may basically be carried out using any elaborate or complex modeling of the vehicle. In particular, one or more degrees of freedom, respectively, up to all six possible degrees of freedom (translation in and rotation about all three spatial directions) may be taken into account for the movement of a vehicle component. However, to reduce the calculating effort it is preferably provided that only the degrees of freedom of the components of the multi-body system which have a primary effect on the detection variable and/or which are primarily affected by the condition parameter are taken into account for the vehicle model.

It has been found that sufficiently precise results may be achieved if movements in the degrees of freedom which only have a slight effect on the detection variable or condition parameter of interest are neglected. If, for example, the detection variable of interest is the axial change in length of a spring, movements in degrees of freedom which only cause a deflection of the spring transversely to its spring axis may be ignored. These movements may also entail a certain axial change in length whose contribution is usually negligible, however.

The observer algorithm can basically also have been generated in any suitable manner. The observer algorithm has preferably been determined using the vehicle model because sufficiently precise results may be achieved particularly easily hereby. Depending on the type and form of the observer algorithm and the type of characteristic of the condition parameter to be determined, solely the vehicle model may have been involved in the determination of the observer algorithm.

In advantageous variants of the invention, the characteristics of the condition parameter to be determined and of the observer algorithm are taken into account as early as when determining the observer algorithm. If, for example, condition parameter disturbances are to be determined the type of which does not correspond to the type of disturbance typically detected by means of the observer algorithm, an adjustment is preferably made by way of the vehicle model used when determining the observer algorithm. In preferred variants of the method according to the invention it is therefore provided that a condition parameter disturbance is determined, wherein the vehicle model has been determined by linearization of the multi-body system, and, to take account of the real noise behavior of the condition parameter disturbance when determining the observer algorithm, a suitable form filter has been used on at least one input of the vehicle model. Form filters of this kind are sufficiently known in vehicle engineering (see for example Laun, R.: Aktive Schwingungsdämpfung durch Adhäsionsregelung auf Basis eines Zustandsreglers; Fachhochschule Offenburg, DE, 1996). For a rail vehicle the corresponding parameters of such form filters may be found for example in the publication “ORE Frage B 176-Drehgestelle mit radial einstellbaren Radsätzen” (Eisenbahntechnische Publikationen—ETF, Paris, FR).

Any suitable mathematical algorithm can be used for the observer algorithm. By way of example, it may be what is referred to as a Luenberg observer, as is known from the publication: Geering, Hans Peter, Regelungstechnik (5th revised and extended edition; Springer Verlag, Berlin, 2001, ISBN 3-540-41264-6). In the present case, a Kalman filter is particularly suitable as the observer algorithm because these are preferably used when the input variables of the system and/or the measured variables are falsified by stochastic variables (“noise”). The solution according to the invention makes use of this advantage in that the track condition disturbance is conceived as the noise that is falsifying the input variables.

The method according to the invention may be applied only after the track section has been passed through using the values of the relevant detection variable captured in the process. It is preferably provided, however, that the method is carried out during the vehicle's journey on the track section, and in particular in real time.

The detection variable(s) can basically be detected at any suitable point in or on the vehicle. The detection variable is preferably determined, and in particular measured, on a running gear of the vehicle, however, because particularly good results are possible hereby when determining the characteristics of the condition parameter.

Basically any detection variables may be detected which allow a conclusion on the characteristics of the condition parameter by way of a correlation manifested in the vehicle model used. A spring deflection of at least one spring unit supported on a wheel of the running gear is preferably used as the detection variable. This has the advantage that corresponding sensors are frequently provided in such running gears anyway (usually for different purposes) and usually easily supply reliable measured values which may be processed further without problems.

As already mentioned, the method according to the invention can basically be used for any vehicles. It may be used particularly advantageously in connection with rail vehicles, so it is preferably provided that the vehicle is a rail vehicle and a characteristic of the track condition, and in particular a track condition parameter disturbance, is determined as the condition parameter.

Basically any suitable modeling of the rail vehicle may also be selected here. The vehicle model has preferably been determined on the basis of an arrangement with two wheel sets, a running gear frame supported on the wheel sets and a wagon body supported on the running gear frame, as particularly good results may be achieved hereby.

It has been found that basically any number of degrees of freedom may be taken into account for the components of the model. As already mentioned, however, preferably only those degrees of freedom which are primarily affected by the track condition are taken into account when determining the track condition. For the vehicle model a translation in the direction of the height axis of the vehicle and a rotation about the longitudinal axis of the vehicle are preferably taken into account therefore as degrees of freedom of the two wheel sets, and a translation in the direction of the height axis of the vehicle, a rotation about the longitudinal axis of the vehicle and a rotation about the transverse axis of the vehicle are taken into account as degrees of freedom of the running gear frame and wagon body.

In preferred variants with even more reduced calculating effort the geometric relationships of the components of the vehicle are taken into account. Therefore, for example, the fact that the track condition disturbances acting on a trailing wheel set are different from those at the first wheel set only due to a time delay corresponding to the speed may be taken into account. This can take place in that, in the linearized, model corresponding delay elements are inserted at the inputs of the second wheel set. In advantageous variants of the method according to the invention it is therefore provided that the speed dependent delay of the effect of a condition parameter between the leading wheel set and the trailing wheel set is taken into account in the vehicle model, in particular by way of a speed-dependent delay element.

Modeling of the wheel-rail contact inter alia has a fundamental effect on the design of the method. In certain variants of the method according to the invention, for the vehicle model, the wheel-rail contact is taken into account via a spring-damper assembly, wherein a high rigidity of the spring-damper assembly in the direction of the height axis of the vehicle is assumed in particular. In this case an adaptive, so-called extended Kalman filter is used as the observer algorithm because it is particularly easy to determine the condition parameter herewith. In particular it is possible, in a good approximation, to use the corresponding displacement of the relevant wheel set supplied by the Kalman filter as the condition parameter because this estimate has proven to be sufficiently precise. In preferred variants of the method according to the invention the observer algorithm is therefore designed in such a way that a current estimated value of at least one state variable of the vehicle is used as the current value of the condition parameter.

In other variants of the method according to the invention, for the vehicle model, the wheel-rail contact is assumed to be infinitely rigid. In this case, a direct use of the estimated values supplied by the observer algorithm is not readily possible for the desired characteristic of the condition parameter and the associated current value of the condition parameter is determined with the aid of the model data from the vehicle model, preferably using a current estimated value.

The detected values of the at least one condition parameter may basically be used only currently in the vehicle. However, it is preferably provided that the at least one condition parameter is logged for the track section travelled on in order to make it accessible for subsequent use.

The present invention also relates to a method for controlling a vehicle, in particular a rail vehicle, wherein, using a method according to the invention, at least one characteristic of a condition parameter of a track section currently negotiated is determined on a leading running gear of the vehicle and a trailing running gear of the vehicle is controlled using the determined characteristic of the condition parameter. The above-described advantages when controlling a vehicle can be achieved hereby.

The present invention finally relates to a vehicle, in particular a rail vehicle, having a processing unit which is adapted to carry out the method according to the invention, and a detection unit which is adapted to detect the detection values. The advantages and variants described above in connection with the method according to the invention, to the same extent, may be realized with this vehicle, so reference merely be made to the statements above.

Further preferred embodiments of the invention become apparent from the dependent claims and the following description of preferred embodiments which refers to the accompanying drawings. It is shown in:

FIG. 1 a schematic view of a preferred embodiment of the vehicle according to the invention,

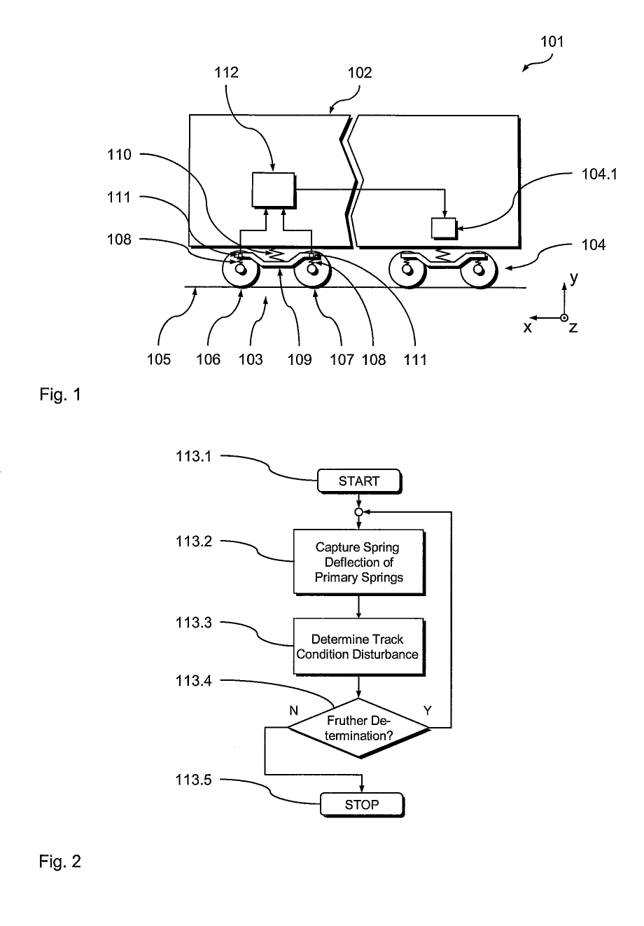

FIG. 2 shows a flow chart of a preferred variant of the method according to the invention which can be carried out with the vehicle from FIG. 1,

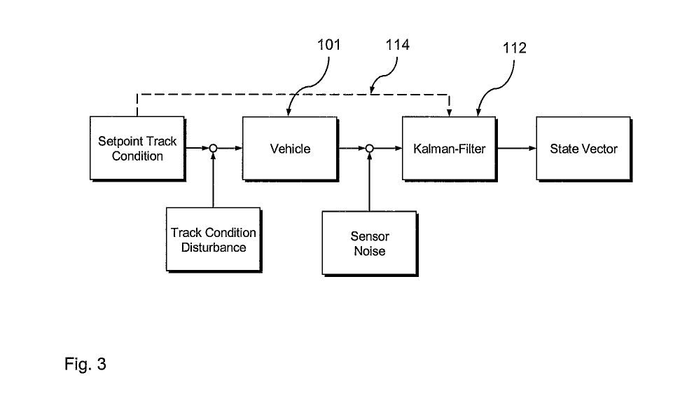

FIG. 3 shows a diagram which illustrates the signal flow when carrying out the method from FIG. 2.

### FIRST EMBODIMENT

A preferred embodiment of the vehicle according to the invention in the form of a rail vehicle 101 will be described hereinafter with reference to FIGS. 1 to 3. For easier understanding of the following statements a coordinate system is shown in FIGS. 1 and 2 in which the x coordinate denotes the longitudinal direction of the rail vehicle 101, the y coordinate denotes the transverse direction of the rail vehicle 101 and the z coordinate denotes the height direction of the rail vehicle 101.

FIG. 1 shows a schematic side view of part of the vehicle 101 which comprises a vehicle longitudinal axis 101. The vehicle 101 comprises a wagon body 102 which is supported in the region of its two ends on a respective running gear in the form of a bogie 103 and 104. The bogies 103 and 104 are in turn supported on a track 105.

The bogie 103 that leads in the direction of travel comprises two wheel sets 106 and 107 on whose two wheel bearings a bogie frame 109 is supported by way of a respective primary suspension 108. The wagon body 102 is in turn supported on the bogie frame 109 by way of a secondary suspension 110.

A sensor 111 is associated with each of the four primary suspensions 108 as a detection device and measures the change in length of the primary suspension 108 in the axial direction (here: z direction) of the primary suspension 108.

The measuring signals of the four sensors 111 are supplied to a central processing unit 112 and are processed therein in the manner described below according to the method according to the invention to determine the track condition disturbances of the track 105.

The sequence of the method is started firstly in a step 113.1 during the journey of the vehicle 101 on a predefined section of the track 105 to be investigated. The current measured values of the four sensors 111 are then detected in a step 113.2 and are passed to the processing unit 112. In a step 113.3, the differences in the track 105 at the respective contact point of the wheels of the wheel sets 106 and 107 from a desired track condition in the z direction are then determined in the processing unit 112 as the track condition disturbances and are stored in a memory of the processing unit 112 for logging (and optionally subsequent further processing). It is then checked in a step 113.4 whether further determination of the track condition disturbances should be carried out. If this is the case, the method jumps back to step 113.2. Otherwise the procedure is ended in a step 113.5.

FIG. 3 shows the signal flow during execution of the method of FIG. 2. As may be seen from FIG. 3, the real track condition is applied as the input variable to the vehicle 101 driving on the track 105, with the real track condition being composed of the desired track condition and the superimposed track condition disturbances. As output variables the sensors 111 on the vehicle 101 supply one measuring signal respectively which, superimposed with the noise from the sensors, is stored in the processing unit 112.

To determine the track condition disturbances the processing unit 112 uses a previously determined observer algorithm, stored in the memory of the processing unit 112, in the form of a Kalman filter, as is sufficiently known from the field of control engineering.

The Kalman filter has been previously determined using a vehicle model in the form of a mathematical model of the vehicle 101. The vehicle model has been determined using a non-linear, dynamic multi-body model, as is sufficiently known from the field of vehicle dynamics and is frequently used for predetermining the driving safety and running quality of vehicles.

In vehicle models of this kind the state space of the system is often modeled by linear differential equations or difference equations which describe the dynamic characteristics of the relevant system and, in time-continuous models, typically have the following form:

$$\begin{matrix}\frac{d x}{d y} = \underline{A} x + \underline{B} u , & ( 1 ) \\ y = \underline{C} x + \underline{D} u , & ( 2 )\end{matrix}$$

where x denotes the state vector of the system and y the output vector and u the input vector of the system and A, B, C, D denote the state space matrices characterizing the system. For time-discrete vehicle models these differential equations are replaced by difference equations of the following form:

xₙ₊₁=Axₙ+Buₙ, (3)

yₙ=Cxₙ+Duₙ, (4)

where n denotes the n^{th} scanning cycle.

The multi-body model has been linearized to simplify the calculations to be carried out by the processing unit 112 (in particular with regard to a real-time determination of the track condition disturbances) by a (likewise sufficiently known) suitable procedure, such that a linear state space model has been obtained as the vehicle model.

In the present example the vehicle model has been determined on the basis of a multi-body arrangement with the two wheel sets 106, 107, the bogie frame 109 supported on the wheel sets 106, 107 and the wagon body 102 supported on the bogie frame 109 (which is modeled in a simplified manner as a point mass in the model).

As has already been mentioned, basically an arbitrarily elaborate or complex modeling of the vehicle 101 is suitable for the method according to the invention. However, to reduce the calculating effort for the processing unit 112, in the present example, only the degrees of freedom of the above components 106, 107, 109 and 102 of the multi-body system are taken into account for the vehicle model which have a primary effect on the spring deflection (i.e. the detection variable) and/or which are primarily affected by the track condition disturbances (i.e. the characteristic of the condition parameter to be determined).

In the present example, for the vehicle model, a translation in the direction of the height axis of the vehicle 101 (z direction) and a rotation about the longitudinal axis of the vehicle (x direction) are taken into account as the degrees of freedom of the two wheel sets 106, 107 and a translation in the direction of the height axis of the vehicle (z direction), a rotation about the longitudinal axis of the vehicle (x direction) and a rotation about the transverse axis of the vehicle (y direction) are taken in account as degrees of freedom of the bogie frame 109 and the wagon body 102.

Modelling of the wheel-rail contact inter alia has a fundamental effect on the design of the method. In the present example, the wheel-rail contact is furthermore taken into account for the vehicle model via a spring-damper assembly, wherein a high rigidity of this spring-damper assembly is assumed in the direction of the height axis of the vehicle (z axis).

When determining the Kalman filter from this vehicle model the characteristics of the Kalman filter are also taken into account. The Kalman filter is usually suitable for processing signals which are subject to what is referred to as white noise. Usually, the track condition disturbances of the track 105 possibly do not correspond sufficiently accurately to such white noise, so in the present example a suitable form filter is used on at least one input of the vehicle model for taking account of the real noise behaviour of the track condition disturbance to be expected when determining the observer algorithm, as has already been described above. However, it is understood that use of such a form filter may eventually also be omitted in other variants of the invention.

The Kalman filter modeled in this way supplies a state vector as an output which, in addition to a renewed estimation of the spring deflections, as discrete states of the vehicle model, reproduces a sufficiently accurate estimate of the condition and speed of the modeled components of the vehicle 101 in the degrees of freedom taken into account. In the present case these are therefore 20 discrete states, namely, for the two wheel sets 106, 107, the amount and speed of the translation in the direction of the height axis of the vehicle 101 (z direction) and the amount and speed of rotation about the longitudinal axis of the vehicle (x direction), and, for the bogie frame 109 and the wagon body 102, the amount and speed respectively of translation in the direction of the height axis of the vehicle (z direction), the amount and speed of rotation about the longitudinal axis of the vehicle (x direction) and the amount and speed of rotation about the transverse axis of the vehicle (y direction).

In the present example the calculating effort for the processing unit 112 is reduced even further by the geometric relationships of the components of the vehicle 101 being taken into account in the subsequent repetitions of steps 113.2 and 113.3 in that it is taken into account that the condition disturbances of the track acting on the trailing wheel set 107 are different from those at the leading wheel set 106 only due to a time delay, corresponding to the speed of the vehicle 101. This consideration occurs, in the present example, in that, in the linearized model, corresponding vehicle speed-dependent delay elements are inserted at the inputs of the modeled second wheel set 107.

Owing to the above-described modeling of the wheel-rail contact as a spring-damper assembly with finite rigidity an adaptive, so-called extended Kalman filter is used in the present case because, herewith, it is particularly easy to determine the track condition disturbances. Therefore, in the present case, it is possible to use, in a good approximation, the values supplied by the Kalman filter as a value for the real track condition for the corresponding shift in the relevant wheel set because this estimation has proven to be sufficiently precise. To determine the track condition disturbances a setpoint track condition (previously determined for the track section) can then be used at the location of the current measurement, as is indicated in FIG. 3. by the outline 114 shown in broken lines, such that, eventually, the state vector output already represents the track condition disturbances.

The processing unit 112 determines the track condition disturbances during the journey of the vehicle 101 on the track in real time and uses the information about the track condition disturbances obtained in this way to control the trailing running gear 104 by transmitting corresponding control commands to the corresponding actuating mechanisms 104.1 of the running gear 104. However, it is understood that, in other variants of the invention, the track condition disturbances may just be appropriately logged.

### SECOND EMBODIMENT

A further preferred embodiment of the method according to the invention will be described hereinafter which can be carried out with the vehicle 101. In its sequence and mode of operation, the method basically corresponds to the method from FIG. 2 so that the differences shall mainly be dealt with here.

The fundamental difference from the first embodiment lies in the fact that the wheel-rail contact is assumed to be infinitely rigid for the vehicle model. In this case, a direct use of the estimated values of the state vector supplied by the Kalman filter cannot be directly used for the track condition disturbances. Instead the associated current value of the track condition disturbances is determined in this example, preferably by using a current estimated value, with the aid of the model data from the vehicle model (which actually reproduces the relationship between the states of the vehicle represented by the state vector and the track condition disturbances).

The following equation may be used for this purpose:

u(t)=D⁻¹·y(t)+D⁻¹·C·x(t), (5)

if the matrix D is square (i.e. the number of inputs is equal to the number of outputs) and its norm is not equal to zero (for example, the outputs are independent).

A more general method for determining the current values of the inputs (i.e. the condition parameter) may be derived in the case of an empty matrix D from equation (5). The following equation may be used (inter alia for time-discrete models):

uₙ=(C·B)⁻¹·(yₙ₊₁−C·A·xₙ), (6)

if the matrix (C·B) is square (e.g. the number of inputs and outputs is equal). By suitable selection of the input and detection variables it should preferably be ensured in this connection that the matrix C and the matrix B are designed in such a way that matrix (C·B) has full rank.

If the matrix D from equation (5) or matrix (C·B) from equation (6) is not square or matrix (C·B) does not have full rank, its respective inverses cannot be directly calculated. In this case what are referred to as (sufficiently known) algorithms can be used to form what are referred to as pseudo-inverses.

It is understood that the procedure just described for determining the current values of the inputs (i.e. the condition parameter) using equations (5) and (6) may also be used for the vehicle model with the rail-wheel contact with finite rigidity from the first embodiment.

### THIRD EMBODIMENT

A further preferred embodiment of the method according to the invention will be described hereinafter which can be carried out with the vehicle 101. In its sequence and mode of operation the method basically corresponds to the method from FIG. 2 so the differences will mainly be dealt with here.

In this variant use of an observer algorithm is omitted. Instead, the vehicle model is configured as a time-discrete model in such a way that the current value of the condition parameter is calculated in a recursive method from the detection values as a function of the model data from the vehicle model. The following equations are used here in addition to equation (3) given above:

x₁=x₀ (7)

uₙ=D⁻¹·yₙ−−D⁻¹·C·xₙ, (8)

if the matrix D is square and its norm is not equal to zero. If the matrix D is not square its inverse again cannot be directly calculated. In this case, what are referred to as (sufficiently known) algorithms to form what are referred to as pseudo-inverses may again be used.

It is understood that in further variants of the method according to the invention, independently of the representation of the wheel-rail contact, the track can be modeled as resilient or resiliently mounted component. In this case, it is possible to estimate the desired input variable, i.e. the condition parameter, directly by way of the observer algorithm without additional calculation steps being required. It should be noted at this point that this is an idea that is capable of being protected independently.

The present invention has been described above solely with reference to examples for a rail vehicle. However, it is understood that the invention may also be applied in conjunction with any other vehicles.

1. A method for determining a characteristic of at least one condition parameter of a track for a vehicle, comprising
detecting on a vehicle driving along a section of the track detection values of at least one detection variable affected by the condition parameter, and
determining the at least one condition parameter for the track section from the detection values,
wherein
a current value of the condition parameter is determined from the detection values as a function of model data from a previously determined vehicle model of the vehicle, and
a relationship between the condition parameter and the at least one detection variable affected by the condition parameter is generated by way of the vehicle model.

2. The method according to claim 1, wherein
the at least one condition parameter for the track section is determined using an observer algorithm adapted to produce, as a function of a current detection value, an associated current estimated value of at least one state variable of the vehicle which is affected by the condition parameter, and
the current value of the condition parameter is determined as a function of the model data from a previously determined vehicle model of the vehicle, wherein
the vehicle model represents the relationship between the condition parameter and the at least one state variable.

3. The method according to claim 1, wherein
the vehicle model has been determined using a dynamic multi-body model, and
the vehicle model has been determined by linearization of the multibody model.

4. The method according to claim 3, wherein only the degrees of freedom of the components of the multi-body system which have a primary effect on the detection variable, which are primarily affected by the condition parameter, or both are taken into account for the vehicle model.

5. The method according to claim 2, wherein the observer algorithm has been determined using the vehicle model.

6. The method according to claim 3, wherein a condition parameter disturbance is determined, wherein the vehicle model has been determined by linearization of the multi-body model and a suitable form filter has been used on at least one input of the vehicle model for taking account of the real noise behavior of the condition parameter disturbance when determining the observer algorithm.

7. The method according to claim 2, wherein a Kalman filter is used as the observer algorithm.

8. The method according to claim 1, wherein the method is carried out during the journey of the vehicle on the track section.

9. The method according to claim 1, wherein the detection variable is determined on a running gear of the vehicle.

10. The method according to claim 9, wherein a spring deflection of at least one spring unit supported on a wheel of the running gear is determined as the detection variable.

11. The method according to claim 1, wherein then vehicle is a rail vehicle and a characteristic of a track condition is determined as the condition parameter.

12. The method according to claim 11, wherein the vehicle model has been determined on the basis of an arrangement having two wheel sets, a running gear frame supported on the wheel sets and a wagon body supported on the running gear frame.

13. The method according to claim 12, wherein, for the vehicle model,
a translation in a direction of a height axis of the vehicle and a rotation about a longitudinal axis of the vehicle are taken into account as degrees of freedom of the two wheel sets and
a translation in a direction of a height axis of the vehicle, a rotation about a longitudinal axis of the vehicle and a rotation about a transverse axis of the vehicle are taken into account as degrees of freedom of the running gear frame and the wagon body.

14. The method according to claim 12, wherein a speed dependent delay in the effect of a condition parameter between a leading wheel set and a trailing wheel set is taken into account in the vehicle model.

15. The method according to claim 11, wherein
a wheel-rail contact is taken into account for the vehicle model via a spring-damper assembly.

16. (canceled)

17. The method according to claim 16, wherein the observer algorithm is configured in such a way that a current estimated value of at least one state variable of the vehicle is used as the current value of the condition parameter.

18. The method according to claim 11, wherein, for the vehicle model, a wheel-rail contact is assumed to be infinitely rigid.

19. The method according to claim 18, wherein, using a current estimated value, the associated current value of the condition parameter is determined with the aid of model data from the vehicle model.

20. The method according to claim 1, wherein the at least one condition parameter for the track section is logged.

21. The method according to claim 1, wherein the current value of the condition parameter is calculated in a recursive method from the detection values as a function of the model data from the vehicle model.

22. A method for controlling a vehicle comprising:
determining on a leading running gear of the vehicle at least one characteristic of a condition parameter of a track section currently being driven along using a method according to claim 1, and
controlling a trailing running gear of the vehicle using the determined characteristic of the condition parameter.

23. A vehicle comprising
a processing unit which is adapted to carry out a method according to claim 1, and
a detection unit which is adapted to detect the detection values.

24. The method according to claim 2, wherein the vehicle is a rail vehicle and a characteristic of a track condition is determined as the condition parameter;
a wheel-rail contact is taken into account for the vehicle model via a spring-damper assembly; and
an extended Kalman filter is used as the observer algorithm.
